(19) United States
(12) Patent Application Publication
(10) Pub. No.: US 2007/0245975 A1
(43) Pub. Date: Oct. 25, 2007

(54) Self-operating animal vacuum device

(76) Inventors: Laura Lynn Udelle, Punta Gorda, FL (US); Steven Daniel Udelle, Punta Gorda, FL (US)

Correspondence Address: LAURA L. UDELLE, 307 BARCELONA STREET, PUNTA GORDA, FL, 33983, US

(21) Appl. No.: 11/408,742

(22) Filed: Apr. 21, 2006

(51) Int. Cl. A01K 13/00

(52) U.S. Cl. 119/600

(57) ABSTRACT

A self-operating device comprising a vacuum grooming housing assembly (A3), a filter (9), a cover assembly (B3), and a blower assembly (C3). Blower assembly (C3) draws loose hair and debris from an animal's coat thereinto openings (7) when the animal is rubbing against the exterior surface (5) of cover assembly (B3). The loose hair and body debris captured from the animal's coat is held in the containment filter (9). The self-operating device is always ready to vacuum groom an animal's coat without any need for human participation or assistance in the vacuum grooming process.

### FIELD OF INVENTION

The present invention relates to animal vacuum devices and more particularly to a vacuum grooming device and method that excludes the participation or assistance of a human with the vacuum grooming process of an animal.

### BACKGROUND—DISCUSSION OF PRIOR ART

While there are many animal vacuuming devices depicted in the prior art, these devices still require human participation to be useful. The enclosed prior art researched does not show, anticipate, or teach of such a device that would perform the vacuum grooming process on an animal without human assistance. Examples of vacuum grooming devices requiring human assistance or participation are Patent Numbers: U.S. Pat. No. 3,574,885, U.S. Pat. No. 3,668,736, U.S. Pat. No. 4,218,806, U.S. Pat. No. 4,630,329, U.S. Pat. No. 4,729,147, U.S. Pat. No. 4,799,460, U.S. Pat. No. 4,907,540, U.S. Pat. No. 4,926,796, U.S. Pat. No. 5,074,006, U.S. Pat. No. 5,095,853, U.S. Pat. No. 5,502,873, U.S. Pat. No. 5,517,945, U.S. Pat. No. 5,540,186, U.S. Pat. No. 5,628,282, U.S. Pat. No. 5,680,831, U.S. Pat. No. 5,655,481, and U.S. Pat. No. 5,826,300.

### SUMMARY

With the current economy requiring two incomes to support the present standard of living, more couples find that their pet animals are left at home unattended for longer periods of time. Most families, more or less, live with the problem of animal hair since there are no effective devices available on the market that would groom and vacuum loose hair and debris from an animal's coat without human participation.

The most difficult to control is the daily dilemma of loose animal hair. It clings to clothing and carpeting, gets imbedded into the fibers of fabric upholstery and window treatments, and can be difficult to remove. Loose animal hair and dander can also be a health hazard to humans by getting into food, or causing allergies by getting into a person's eyes, nose, or more seriously their lungs. When brushing is neglected due to an owner's hectic schedule, loose hair can get totally out of control.

The present invention is designed to help overcome the ongoing problems as described above. The present invention serves as a substitute for human interaction in the grooming vacuuming process. The present invention permits an animal to self-groom and have its loose hair vacuumed at the same time whenever the animal should choose to rub its coat against the device, day or night.

The following specifications and teachings are based on the operation and performance of applicants' working prototypes as used by their three cats.

Generally, the self-operating animal vacuum device comprises a housing assembly forming a base having a cover assembly supported by a continuous side wall. A blower assembly, fan assembly, or current of air moving device or assembly is disposed therein the interior space of the housing assembly. The blower assembly comprises a blower housing having a blower wheel directly coupled to a shaft disposed therein the blower housing, a motor to rotate the shaft, an air inlet opening in the blower housing adjacent to the blower wheel, and a discharge air outlet opening disposed thereat an exhaust vent opening disposed therethrough the side wall of the housing assembly.

The cover assembly comprises a removably attached cover having an exterior surface serving as a rubbing medium for an animal, an underside opening for receiving therein a debris containment element or filter, and a plurality of openings disposed therethrough the exterior surface of the cover for drawing in animal debris.

The electrical system of the housing assembly comprises an on/off switch, a detector or sensor, a synthesizer, related wiring, and an adjustable power cord.

A typical sequence of operation for the self-operating animal vacuum device begins with the on/off switch engaged to the on position, whereby a synthesizer quietly broadcasts intermittent animal attractant sounds such as mouse scratching, mouse squeaking, or other sounds an animal may find enticing or soothing. The synthesizer provides a positive means for introducing and luring an animal to use the device.

Once the animal becomes acquainted with the device, its basic instincts for rubbing and leaving its scent will take over. The animal will then routinely utilize the device to rub against simply because it feels good.

An optical, motion, pressure, sound sensor, or the like closes an electrical circuit to the air-moving assembly upon contact or close proximity of an animal to the device and will start the vacuum grooming process. The sensor is provided with a built-in time delay, whereby the air moving assembly will deactivate in a predetermined period of time after an animal has departed from the device. The delay timer prevents unnecessary short-cycling of the air moving assembly. When the sensor starts the vacuum process, it will also deactivate the synthesizer by opening a normally closed contact built into the sensor.

An air moving assembly disposed therein the interior space of the housing assembly freely draws a current of air thereinto the plurality of openings disposed therethrough the exterior surface of the cover, therethrough a debris containment element or filter disposed under the opening of the cover, thereinto the interior space of the housing assembly, and therethrough the air inlet opening disposed therein the housing adjacent to the blower wheel. The velocity of the current of air flow drawn thereinto the plurality of openings disposed therethrough the exterior surface of the cover is capable of drawing or sucking adjacent loose animal hair and body debris created by the rubbing efforts of an animal against the exterior surface of the cover, thereinto openings disposed therethrough the exterior surface and deposited thereon the large surface area of the debris containment element or filter.

The typical sequence of operation ends as the unit shuts off automatically when the animal departs from the device. An optical, motion, pressure, sound sensor, or the like opens the electrical circuit to the air-moving assembly upon the departure of an animal from the device and will conclude the vacuum process.

The cover assembly and debris containment element or filter are removably attached for cleaning and sanitizing. The exterior rubbing surface of the cover assembly can be integrally molded with texture or protrusions to further aid in the removal of loose hair and debris. Another optional rubbing material suitable for an animal to rub its coat thereon, such as semi-rigid combing teeth or flexible bristles can be placed thereon the exterior surface of the cover. Another optional rubbing surface material, such as a mat can be placed thereon the top exterior cover surface of the horizontal device for use as a bed.

The device may be wall mounted or in a free standing horizontal position. The discharge air outlet opening of the air moving assembly housing quietly discharges filtered air therethrough the exhaust air vent openings disposed therein the housing assembly side wall. The enlarged discharge air opening significantly reduces the face velocity of air flow and sound level therethrough the exhaust air vent openings produced by the current of air moving assembly.

While the above teachings describe one sequence of operation, a second method for operating the device can be employed, such as allowing the device to operate by means of an on/off switch only. This mode of operation still provides the same usefulness and exclusion of full human participation in the vacuum grooming process.

The air moving assembly of the device is as long-term reliable as a common fan. The air moving assembly described above is totally devoid of the familiar and annoying high-pitched sounds usually associated with vacuum cleaning devices and noisy cooling fans.

It is therefore an object and advantage of the present invention to provide an improved animal grooming device that significantly improves the living environment of animal owners by reducing the amount of animal hair and body debris carried by domestic animals that is also associated with human allergies.

Another object of the invention is to provide an improved device that is always ready to groom and vacuum an animal's coat any time the animal instinctively feels the desire to rub thereon, without the assistance or participation of the pet owner, thereby taking advantage of the animal's negative trait of all too frequent rubbing and using it to a positive advantage.

Another object of the invention is that the device effectively entices the animal to spend more productive time with the automatic grooming vacuuming process, thereby removing more loose hair that would normally be ingested by the animal causing furballs.

Another object of the invention is that the device automatically eliminates loose hair and debris from an animal as the animal sleeps or rests on the device.

Another object of the invention is to contain loose hair and body debris within the device and prevent its spread throughout the living environment saving the owner countless hours of cleaning up loose animal hair.

Another object of the invention is that the device alleviates the pet owner from the time consuming chore of brushing or vacuuming their pet by hand.

Further objects and advantages of the present invention will become apparent from a consideration of the drawings and ensuing descriptions.

### BRIEF DESCRIPTION OF DRAWINGS

FIG. 1a shows an exploded perspective view of related assemblies forming a self-operating animal vacuum device as mounted to a vertical surface.

FIG. 1b shows an exploded perspective view of an alternate embodiment of FIG. 1a showing an alternate type of air-moving assembly for vertical or horizontal free-standing applications.

FIG. 1c shows an exploded perspective view of a preferred alternate embodiment of FIG. 1a set on a horizontal surface for use as an animal bed showing a mat-like rubbing means.

FIG. 1d shows an exploded perspective view of a vertical wall mounted alternate embodiment of FIG. 1a showing a curved upper cover portion to conform to the contours of the animal.

FIG. 1e shows an exploded perspective view of a vertical wall mounted alternate embodiment of FIG. 1a showing an arched tunnel-shaped upper cover to conform to the top and both sides of an animal with a claw-scratching surface.

FIG. 1f shows an exploded perspective view of FIG. 1e having a hollow platform base creating a free-standing device with claw-scratching surfaces and openings to draw fallen hair within the device.

### COMPLETE DESCRIPTION OF THE INVENTION

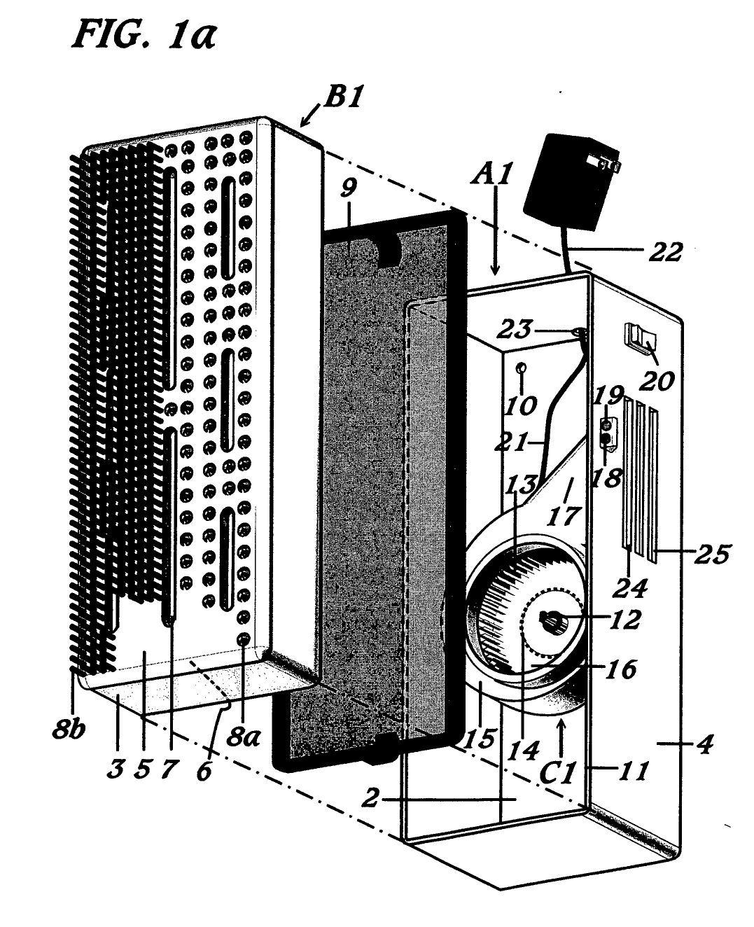

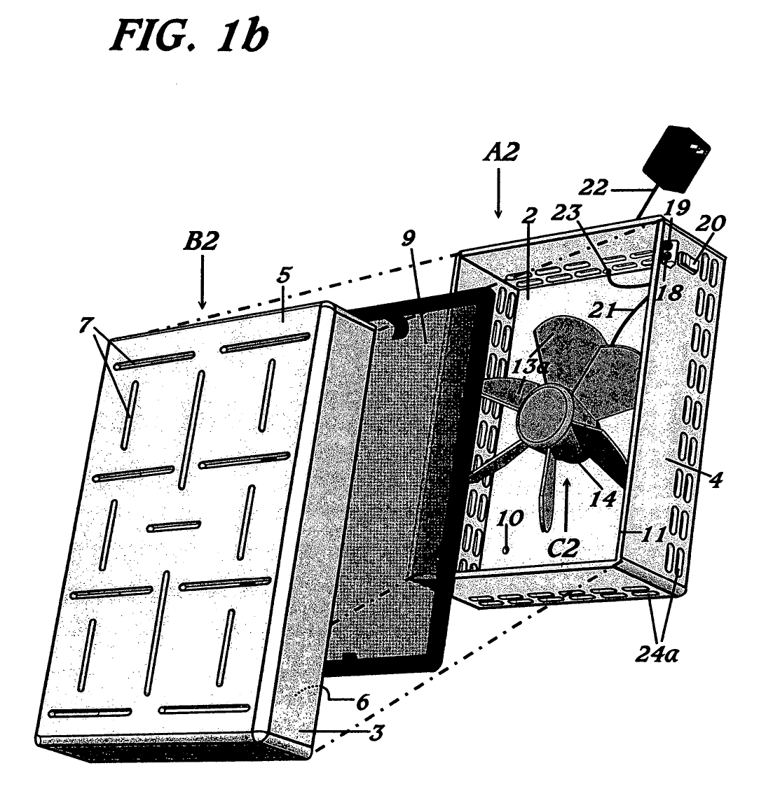

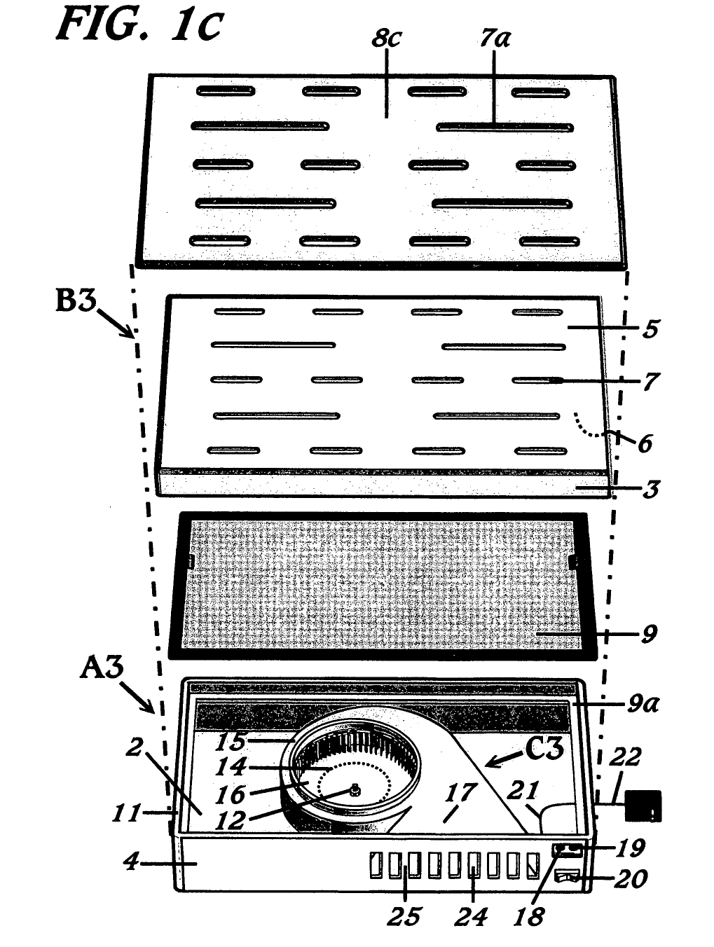

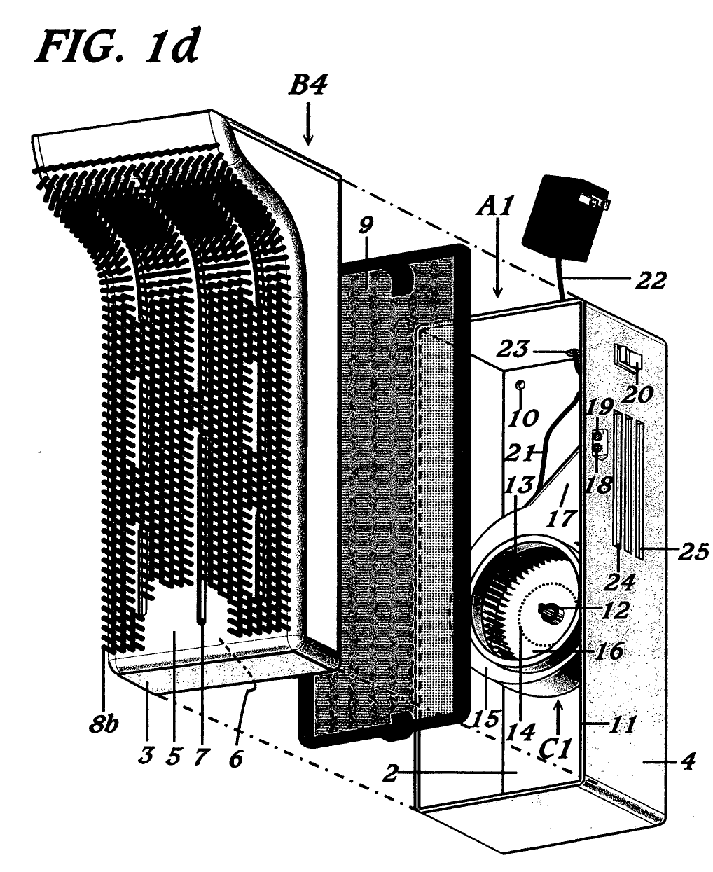

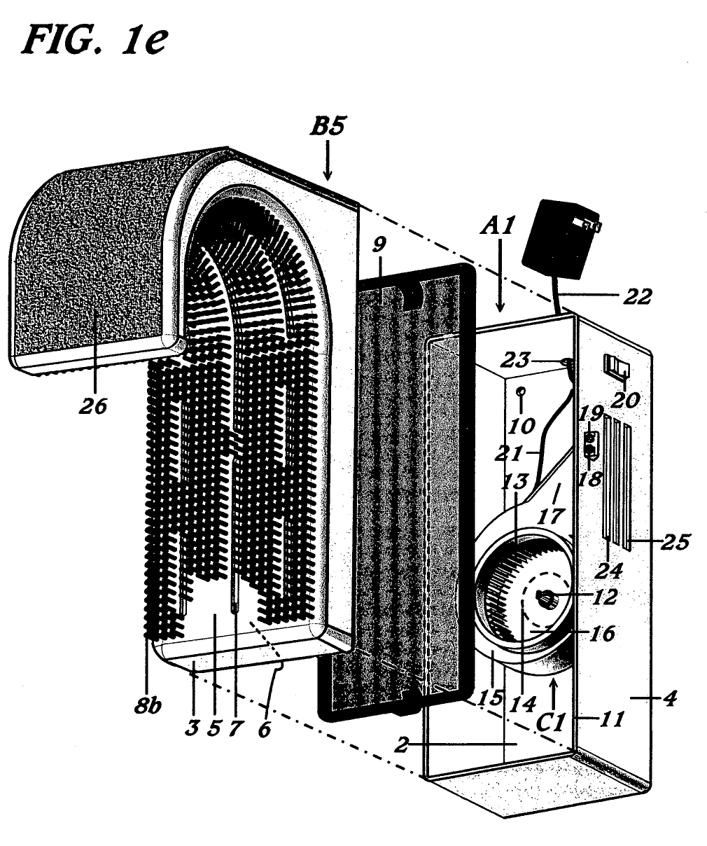

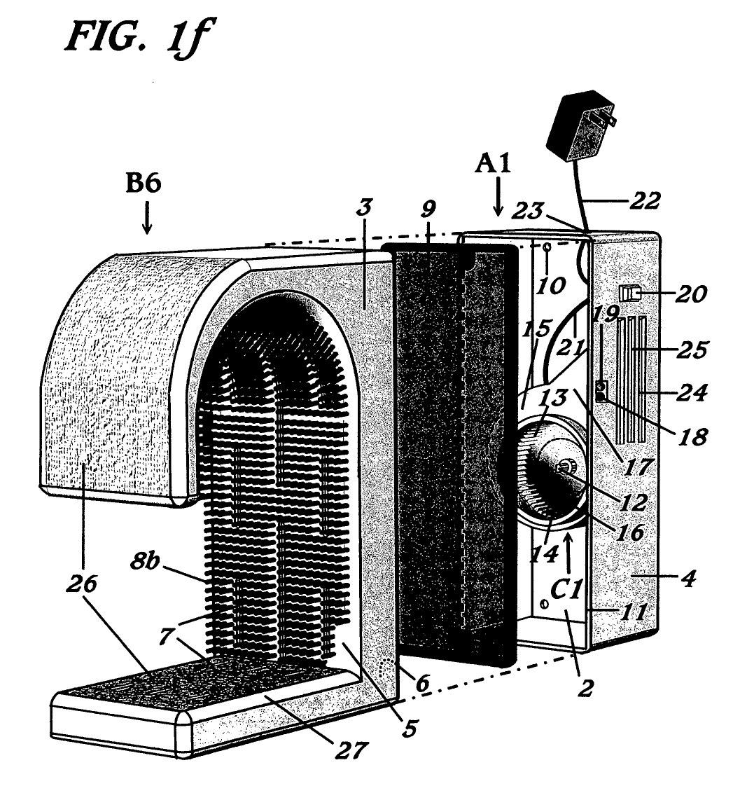

FIG. 1a is an exploded perspective view of a wall mounted self-operating animal vacuum device showing housing assembly A1, cover assembly B1, and an air-moving assembly C1.

Housing assembly A1 comprises a housing forming a base 2 having a plurality of wall-mounting holes 10, and a removably attached cover 3 supported by a continuous side wall 4.

Cover 3 fits around upper edge portion 11 of side wall 4 completing an enclosure.

Debris containment filter 9 is disposed therein underside recessed opening 6 of cover assembly B1.

Housing cover assembly B1 further comprises a plurality of openings 7 disposed therethrough cover exterior surface 5, whereby a current of air can be freely drawn by air moving assembly C1 thereinto the plurality of openings 7, therethrough debris containment element or filter 9, therein interior space of housing assembly A1, and thereinto air inlet opening 16 of blower housing 15.

Exterior surface 5 surrounding openings 7 serves as a rubbing medium for an animal. A rubbing surface 8a suitable for an animal to rub its coat thereon can be integrally molded therewith exterior surface 5, such as a textured surface or protrusions. Another optional rubbing surface material 8b suitable for an animal to rub its coat thereon can be placed thereon exterior surface 5, such as semi-rigid combing teeth or flexible bristles 8b.

Air moving assembly C1 disposed therein housing assembly A1 comprises a blower assembly having a blower wheel 13 directly coupled to shaft 12 disposed therein blower housing 15. Shaft 12 is rotated by electric motor 14 shown in hidden lines. Air moving assembly C1 further comprises a suction or inlet air opening 16 and a discharge air outlet 17 affixed thereto exhaust air vent openings 24 disposed therethrough exhaust air vent side wall 4. Opening 24 further comprises a plurality of spaced air deflecting blades 25 disposed thereat exhaust air vent openings 24.

The electrical system of housing assembly A1 comprises an on/off switch 20, detector or sensor 18, synthesizer 19, related wiring 21, and a power cord 22. Power cord 22 is shortened or lengthened by pushing or pulling power cord 22 through friction fitting grommet 23 disposed therewith housing side wall 4, whereby more options are available to the consumer for wall mounting height considerations for the device, and relative location to an electrical wall outlet receptacle. Power cord 22 can range in length from six inches to eighteen inches or more. Any unnecessary power cord slack is pushed through friction grommet 23.

A typical sequence of operation for the self-operating animal vacuum device begins with the on/off switch 20 engaged to the on position, whereby synthesizer 19 is activated. Synthesizer 19 quietly broadcasts intermittent animal attractant sounds such as mouse scratching, mouse squeaking, or other sounds an animal may find enticing or soothing. Synthesizer 19 provides a positive means for luring an animal to use the device.

An optical, motion, pressure, sound, or heat sensor 18 or the like, closes an electrical circuit to air moving assembly C1 upon contact or close proximity of an animal to the device and will start the vacuum grooming process. Sensor 18 is provided with a built-in delay timer whereby air moving assembly C 1 will deactivate in a predetermined period of time after an animal has departed from the device. The delaying timer prevents unnecessary short-cycling of air moving assembly C1. When sensor 18 starts the vacuum grooming process, it will also deactivate the synthesizer 19 by opening a normally closed contact built into sensor 18.

Oversized blower wheel 13 of air moving assembly C1 rotates at a preselected RPM, whereby a predetermined negative current of air flow pressure or suction is sustained at air inlet opening 16 adjacent to blower wheel 13, the interior space of housing assembly A1, and openings 7 disposed therethrough exterior surface 5 of cover assembly B1.

The interior space of housing assembly A1 serves as a large negative air pressure or vacuum reservoir that draws a sufficiently uniform current of air flow from outside the device thereinto each opening 7 disposed therethrough exterior surface 5 of cover assembly B1. The velocity of the current of airflow drawn thereinto openings 7 disposed therethrough exterior surface 5 is capable of drawing or sucking adjacent loose animal hair and body debris created by the rubbing efforts of an animal against exterior surface 5, thereinto openings 7 disposed therethrough exterior surface 5, and deposited thereon the large surface area of debris containment element or filter 9.

Cover assembly B1 and debris containment element or filter 9 are removably attached for cleaning and sanitizing.

The enlarged discharge air outlet 17 of blower housing 15 substantially reduces the face velocity and sound level of pressurized filtered air passing therethrough exhaust air vent openings 24 disposed therein side wall 4. The discharge air is deflected at a predetermined angle by a plurality of angled air-deflection blades 25 disposed therewith exhaust air vent openings 24.

While the above teachings describe one sequence of operation, a second method for operating the device can be employed, such as allowing the device to operate continuously by means of an on/off switch only. This mode of operation still provides the same usefulness and exclusion of human participation or assistance in the vacuum grooming process. Air moving assembly C1 is as long-term reliable as the commonly used household fan.

FIG. 1b is an exploded perspective view of an alternate embodiment or modification of FIG. 1a showing housing assembly A2, cover assembly B2, and an alternate air moving assembly C2. Housing assembly A2 is a modified version of housing assembly A1 of FIG. 1a, wherein a plurality of exhaust air vent openings 24a are disposed therethrough all opposing sides of continuous side wall 4.

Housing assembly A2 can be rigidly mounted to a wall surface by mounting holes 10 or can be free standing against a wall surface.

Cover assembly B2 is the same as cover assembly B1 of FIG. 1a with additional openings 7 disposed orthogonally on exterior surface 5.

A conventional air moving assembly C2 disposed therein housing assembly A2 comprises a fan having a motor 14a and a plurality of selectively pitched blades 13a, wherein air moving assembly C2 can draw a current of air thereinto a plurality of openings 7 disposed therethrough exterior surface 5 serving as a rubbing surface medium of cover 3, therethrough debris containment filter 9 and thereinto the interior space of housing assembly A2.

The electrical system, other element number descriptions, the sequences of operation and additional benefits of FIG. 1b are the same as fully described in the specifications and drawings of FIG. 1a.

FIG. 1c is an exploded perspective view of an alternate embodiment or modification of FIG. 1a shown as an animal bed comprising housing assembly A3, cover assembly B3, and blower assembly C3. Housing assembly A3 is the same as housing assembly A1 of FIG. 1a except for the addition of continuous ledge 9a disposed thereon upper portion of interior side wall 4. Continuous ledge 9a supports debris containment filter 9 disposed therein interior space of housing assembly A3.

Cover assembly B3 is the same as cover assembly B1 of FIG. 1a except the cover is larger in size and has a greater number of openings 7 disposed therethrough exterior surface 5 of cover 3.

An optional washable, removably attached mat or rubbing material 8c is disposed thereon exterior surface S of cover 3 and having wider openings 7a that align with openings 7 disposed therethrough exterior surface of cover 3 and held in place by conventional hook and loop strips (not shown). Rubbing material 8c is comprised of a flexible material suitable for an animal to rub its entire body thereon and suitably resilient for an animal to rest or sleep thereon.

Air moving assembly C3 is the same as air moving assembly C1 of FIG. 1a.

Rubbing material 8c can also be electrically heated.

The above alternate embodiment FIG. 1c is free-standing and positional anywhere on a floor surface. The above device can be sized for the smallest cat, the largest dog, and can be used by any other species of animal.

The electrical system, the remaining other element number descriptions, the sequences of operation and additional benefits of FIG. 1c are the same as fully described in the specifications and drawings of FIG. 1a.

FIG. 1d is an exploded perspective view of an alternate embodiment or modification of FIG. 1a showing the housing cover B4 with a curved upper portion to conform to the contours of an animal's upper body.

The electrical system, the other remaining element number descriptions, the sequences of operation and additional benefits of FIG. 1d are the same as fully described in the specifications and drawings of FIG. 1a.

FIG. 1e shows an exploded perspective view of an alternate embodiment of FIG. 1a showing the housing cover B5 with an arched tunnel-shaped upper portion 5a to conform to the top and both sides of an animal as the animal rubs against the device.

An optional claw-scratching material 26 is affixed to the top side of the arched tunnel-shaped housing cover B5.

The electrical system, the other remaining element number descriptions, the sequences of operation and additional benefits of FIG. 1e are the same as fully described in the specifications and drawings of FIG. 1a.

FIG. 1f shows an exploded perspective view of FIG. 1e with the addition of a hollow platform base 27 to create a free-standing device with claw-scratching surfaces 26. The base 27 has openings 7 for loose fallen hair to get drawn into the debris containment filter 9.

The electrical system, the remaining other element number descriptions, the sequences of operation and additional benefits of FIG. 1f are the same as fully described in the specifications and drawings of FIG. 1a.

### CONCLUSION

Thus it has been shown that the Self-Operating Animal Vacuum Device can perform all of the objectives as outlined above and provides practical and fully functional improvements that exhibit substantial novelty, un-obviousness, usefulness, and synergism over like prior art devices.

Although the descriptions above contain many specificities, these should not be construed as limiting the scope of the invention but as merely providing illustrations of some of the preferred embodiments or modifications herein detailed in accordance with the descriptive requirements of law. It should be understood that the details are to be interpreted as illustrative and not in a limiting sense. Thus the scope of the invention should also be determined by the appended claims and their legal equivalents.

We claim:

1. A self-operating animal vacuum grooming device comprising:
a) a housing means, said housing means having a cover means and an interior space;
b) said cover means of said housing means having an exterior surface means, said exterior surface means serving as a rubbing means;
c) said cover means of said housing means having at least one opening disposed therethrough said exterior surface means of said cover means, whereby a current of air is drawn thereinto said at least one opening disposed therethrough said exterior surface means of said cover means; and
d) means, said means disposed therein said interior space of said housing means, said means disposed therein said housing means freely drawing said current of air thereinto said at least one opening disposed therethrough said exterior surface means of said cover means and thereinto said interior space of said housing means, whereby when an animal is rubbing its coat thereon said exterior surface means serving as a rubbing means, loose debris from said animal's coat is captured by said current of air and drawn with said current of air thereinto said at least one opening disposed therethrough said exterior surface means and thereinto said interior space of said housing means, thereby removing said loose debris from said animal's coat without the need for human participation in the vacuum grooming act with said animal.

2. The device of claim 1, wherein said housing means is generally rectangular.

3. The device of claim 1, wherein said cover means further comprises a removably attached said cover means.

4. The device of claim 1, wherein said cover means having a said exterior surface means serving as a rubbing means further comprises an optional textured surface integrally molded therewith said exterior surface means serving as a rubbing means.

5. The device of claim 1, wherein said cover means having a said exterior surface means serving as a rubbing means further comprises an optional rubbing material means disposed thereon said exterior surface means of said cover means suitable for grooming the coat of said animal.

6. The device of claim 1 wherein said housing means further comprises a removably attached debris containment means disposed therein said interior space of said housing means.

7. The device of claim 1, wherein said at least one opening disposed therethrough said exterior surface means of said cover means further comprises a plurality of openings disposed therethrough said exterior surface means of said cover means.

8. The device of claim 1, wherein said means disposed therein said interior space of said housing means said freely drawing a current of air is a fan assembly.

9. The device of claim 1, wherein said means disposed therein said interior space of said housing means said freely drawing a current of air is a blower assembly.

10. The device of claim 1, wherein said means disposed therein said interior space of said housing means said freely drawing a current of air is an air-moving assembly.

11. The device of claim 1, wherein said housing means further comprises a means disposed therewith said housing means, said means disposed therewith said housing means activating said means disposed therein said interior space of said housing means upon close proximity of said animal to said housing means.

12. The device of claim 11, wherein said means activating said means disposed therein said interior space of said housing means includes a sensor means.

13. The device of claim 1, wherein said housing means further includes a synthesizer means disposed therewith said housing means broadcasts animal attractant sounds.

14. The device of claim 1, wherein said housing means is wall-mounted.

15. The device of claim 1, wherein said housing means is free-standing and movable on a floor surface.

16. The device of claim 15, wherein said housing means is free-standing and movable on a floor surface comprises a vacuum bed means for said animal to sleep thereon.

17. The device of claim 1, wherein said exterior surface means of said cover means serving as a rubbing means further comprises a bed surface means for said animal to sleep thereon said exterior surface means.

18. The device of claim 1, wherein said current of air freely drawn thereinto said at least one opening disposed therethrough said exterior surface means of said cover means and thereinto said interior space of said housing means, further includes a filtered said current of air being discharged or exhausted thereto the outside of said housing means by said means disposed therein said interior space of said housing means freely drawing said current of air.

19. The device of claim 1, wherein said cover means of said housing means having an exterior surface means, said exterior surface means serving as a rubbing means includes a portion shaped to follow the contours of said animal's body.

20. The device of claim 1, wherein said cover means of said housing means having an exterior surface means, said exterior surface means serving as a rubbing means includes a portion forming a platform base serving as a claw scratching means.
